(19) United States
(12) Patent Application Publication
(10) Pub. No.: US 2024/0324017 A1
(43) Pub. Date: Sep. 26, 2024

(54) CONTENTION RESOLUTION TECHNIQUES RANDOM ACCESS PROCEDURES

(71) Applicant: QUALCOMM Incorporated, San Diego, CA (US)

(72) Inventors: Jing Sun, San Diego, CA (US); Xiaoxia Zhang, San Diego, CA (US)

(21) Appl. No.: 18/186,908

(22) Filed: Mar. 20, 2023

(51) Int. Cl. H04W 74/08; H04L 5/00; H04W 74/00

(52) U.S. Cl. CPC H04W 74/0833; H04L 5/0048; H04W 74/004

(57) ABSTRACT

Disclosed is a method for wireless communication. The method comprises receiving, from one or more user equipments (UEs), a plurality of random access preambles on a physical random access channel (PRACH). Each random access preamble comprises the same random access preamble sequence. A response message indicating a pool of uplink (UL) resources is transmitted to the one or more UEs. One or more transmissions on a subset of the pool of uplink resources are received from the one or more UEs.

### INTRODUCTION

Aspects of the present disclosure generally relate to wireless communications, and more particularly to techniques, systems and apparatuses for random access contention resolution.

### BACKGROUND

Wireless communication systems have developed through various generations, including a first-generation analog wireless phone service (1G), a second-generation (2G) digital wireless phone service (including interim 2.5G networks), a third-generation (3G) high speed data, Internet-capable wireless service, a fourth-generation (4G) service (e.g., Long-Term Evolution (LTE), WiMax, etc.), and most recently a fifth-generation (5G) service. There are presently many different types of wireless communication systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile communication (GSM), etc.

The 5G mobile telecommunication standard calls for higher data transfer speeds, greater numbers of connections, and better coverage, among other improvements. The 5G standard (also referred to as “New Radio” or “NR”), according to the Next Generation Mobile Networks Alliance, is designed to provide data rates of several tens of megabits per second to each of tens of thousands of users with, for example, a gigabit connection speeds to tens of users in a common location, such as on an office floor. Several hundreds of thousands of simultaneous connections are to be supported in order to support large sensor deployments. Consequently, there is a need for significantly enhancing the spectral efficiency of 5G mobile communications compared to the current 4G/LTE standard. Furthermore, there is also a corresponding need for enhancing signaling efficiencies and substantially reducing latency compared to current standards.

In wireless communication networks, a connection between a base station and a user equipment (UE) is generally achieved by means of a random access procedure which is generally initiated by a UE sending, on a Physical Random Access Channel (PRACH) a PRACH sequence in a first transmission to the base station. Generally, different base stations are assigned with different sets of PRACH sequences. To connect to a base station/cell, a UE selects one of the available/configured PRACH sequences for the base station/cell to initiate the connection with the base station/cell. Discriminability between UEs can conventionally only be achieved as the UEs pick different PRACH sequences to initiate random access.

Thus, conventionally, a network operator would have to assign PRACH resources to the base station such that neighboring base stations do not interfere with each other, i.e., in such a way that two neighboring base stations are not assigned with equal PRACH sequences. Furthermore, a network operator should choose the amount of assigned PRACH sequences for each cell such that it is unlikely that two UEs choose the same PRACH sequence at the same or similar time. However, especially in large cells with many UEs, there is still a chance of contention, i.e., of two or more different UEs initiating a random access procedure by transmitting the same PRACH sequence at the same or similar time. Then, the base station is not able to distinguish between the two UEs, such that the random access procedure can at best be successful for one of the UEs. The other UE will have to reinitiate the random access procedure, thereby wasting valuable resources.

Consequently, it is desirable to provide random access techniques that reduce inter-UE and/or inter-cell interference/contention.

### SUMMARY

The following presents a simplified summary relating to one or more aspects disclosed herein. A more detailed disclosure follows in the next section with reference to the appended drawings.

In some aspects of the present disclosure, a method of wireless communication at a base station is provided. The method may comprise receiving, from one or more user equipments (UEs), a plurality of random access preambles on a physical random access channel (PRACH), each random access preamble comprising the same random access preamble sequence; transmitting, to the one or more UEs, a response message indicating a pool of uplink (UL) resources; and receiving, from the one or more UEs, one or more transmissions on a subset of the pool of uplink resources.

In some aspects of the present disclosure, a method of wireless communication at a user equipment (UE) is provided. The method may comprise transmitting, to a base station, a random access preamble on a physical random access channel (PRACH), the random access preamble comprising a random access preamble sequence; receiving, from the base station, a response message indicating a pool of uplink (UL) resources; randomly selecting a UL resource from the pool of UL resources; and transmitting, to the base station, a transmission on the selected UL resource.

In some aspects of the present disclosure, a method for wireless communication by a base station is provided. The method may comprise receiving, from one or more user equipments (UEs), a plurality of first random access preambles on a physical random access channel (PRACH), each first random access preamble comprising the same first random access preamble sequence; transmitting, to the one or more UEs, a plurality of downlink control information (DCI), each DCI comprising: an indication of the first random access preamble sequence, an indication of a time, at which the first random access preamble was transmitted, and an indication to transmit a second random access preamble; and receiving, from the one or more UEs, a plurality of second random access preambles, each second random access preamble comprising a second random access preamble sequence.

In some aspects of the present disclosure, a method for wireless communication by a UE is provided. The method may comprise transmitting, to a base station, a first random access preamble on a physical random access channel (PRACH), the first random access preamble comprising a first random access preamble sequence; receiving, from the base station, a downlink control information (DCI) comprising: an indication of the first random access preamble sequence, an indication of a time, at which the random access preamble was transmitted, and an indication to transmit a second random access preamble; and randomly selecting a second random access preamble sequence; and transmitting, to the base station, the second random access preamble comprising the second random access preamble sequence.

In some aspects of the present disclosure, a method for wireless communication at a base station comprising multiple transmission reception points (TRPs) is provided. The method may comprise transmitting, from one of the multiple TRPs, to a user equipment (UE), a TRP specific reference signal (RS) comprising a TRP identifier; receiving, from the UE, a random access preamble on a physical random access channel (PRACH) comprising a TRP specific random access preamble sequence generated by the UE based on the TRP identifier.

In some aspects of the present disclosure, a method for wireless communication at a user equipment (UE) is provided. The method may comprise receiving, from one of multiple transmission reception points (TRPs) of a base station, a TRP specific reference signal (RS) comprising an TRP identifier; generating, based on the TRP identifier, a TRP specific random access preamble sequence; transmitting, to the base station, a random access preamble on a physical random access channel (PRACH), the random access preamble comprising the TRP specific random access preamble sequence.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, follows by reference to aspects, some of which are illustrated in the appended drawings. It is to be noted, however, that the appended drawings illustrate only some typical aspects of this disclosure and are therefore not to be considered limiting of its scope. The same reference numbers in different drawings may identify the same or similar elements.

FIG. 1 is a block diagram conceptually illustrating an example wireless communication network.

FIG. 2 is a block diagram conceptually illustrating aspects of an example of a base station (BS) and a user equipment (UE).

FIGS. 3A, 3B, 3C, and 3D depict various example aspects of data structures for a wireless communication network.

FIG. 4 is a block diagram illustrating an example of a base station including/operating multiple transmission reception points (TRPs).

FIG. 5 is a diagram illustrating the reception of several equal random access preambles via two TRPs, in accordance with some aspects of the present disclosure.

FIGS. 6A, 6B and 6C depict example aspects of PRACH contention resolution between two UEs with similar timing advance, in accordance with some aspects of the present disclosure.

FIGS. 7A and 7B depict example aspects of PRACH contention resolution between three UEs with different timing advance, in accordance with some aspects of the present disclosure.

FIGS. 8A, 8B, 8C and 8D depict further example aspects of PRACH contention resolution between two UEs with similar timing advance, in accordance with some aspects of the present disclosure.

FIGS. 9A and 9B depict further example aspects of PRACH contention resolution between multiple UEs, in accordance with some aspects of the present disclosure.

FIG. 10 is a flow chart illustrating an example of a process of wireless communication by a BS, in accordance with some aspects of the present disclosure.

FIG. 11 is a flow chart illustrating an example of a process of wireless communication by a UE, in accordance with some aspects of the present disclosure.

FIG. 12 is a flow chart illustrating an example of a process of wireless communication by a BS, in accordance with some aspects of the present disclosure.

FIG. 13 is a flow chart illustrating an example of a process of wireless communication by a UE, in accordance with some aspects of the present disclosure.

FIG. 14 is a flow chart illustrating an example of a process of wireless communication by a BS comprising multiple TRPs, in accordance with some aspects of the present disclosure.

FIG. 15 is a flow chart illustrating an example of a process of wireless communication by a UE, in accordance with some aspects of the present disclosure.

### DETAILED DESCRIPTION

Various aspects of the present disclosure are described in more detail hereinafter with reference to the accompanying drawings.

The present disclosure may, however, be implemented in many different forms and should not be construed as limited to any specific structure or function presented in the following. Rather, the following aspects are described so that this disclosure will be thorough and complete, and will fully convey the scope of the present disclosure to those skilled in the art. Based on the teachings herein one skilled in the art should appreciate that the scope of the present disclosure is intended to cover any aspect of the present disclosure disclosed herein, whether implemented independently of or combined with any other aspect of the present disclosure. For example, an apparatus may be implemented, or a method may be practiced using any number of the aspects set forth herein. In addition, the scope of the present disclosure is intended to cover such an apparatus or method which is practiced using other structure, functionality, or structure and functionality in addition to or other than the various aspects of the present disclosure set forth herein. It should be understood that any aspect of the present disclosure disclosed herein may be implemented by one or more elements of a claim. While specific feature combinations are described in the following with respect to certain aspects of the present disclosure, it is to be understood that not all features of the discussed examples must be present for realizing the technical advantages of the devices, systems, methods and computer programs disclosed herein. Disclosed aspects may be modified by combining certain features of one aspect with one or more features of other aspects. A skilled person will understand that features, steps, components and/or functional elements of one aspect can be combined with compatible features, steps, components and/or functional elements of any other aspect of the present disclosure.

Several aspects of communication systems will now be presented with reference to various apparatuses, systems and techniques. These apparatuses, systems and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with 3G and/or 4G wireless technologies, aspects of the present disclosure can be applied in other generation-based communication systems, such as 5G and later, including NR technologies and Open RAN (O-RAN) technologies.

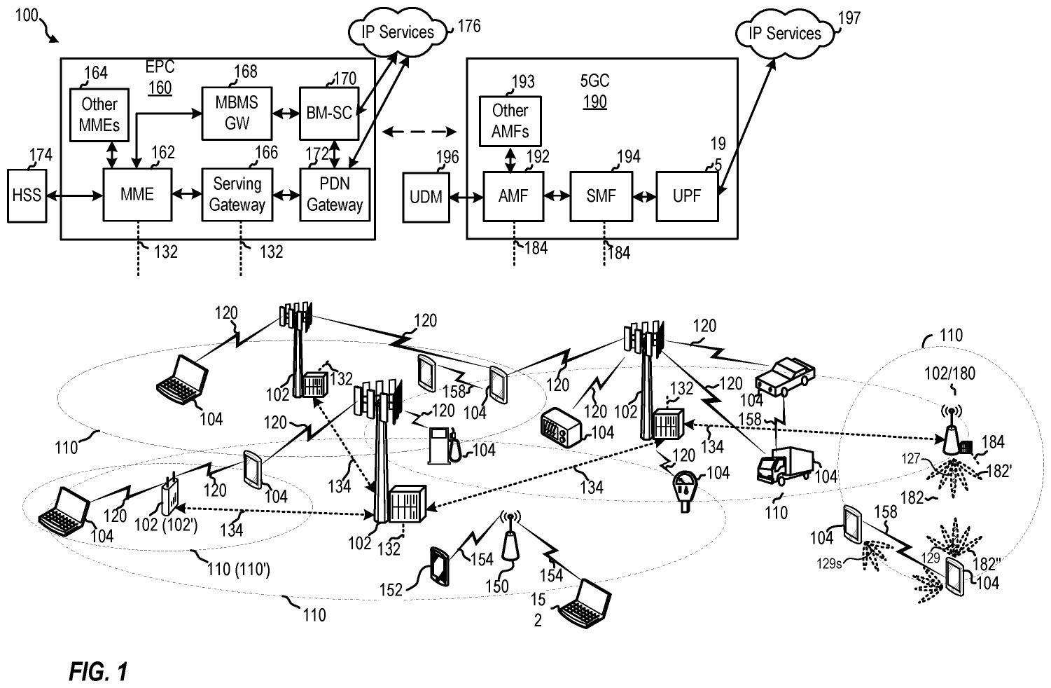

FIG. 1 depicts an example of a wireless communication network 100, in which aspects described herein may be implemented.

Generally, wireless communication network 100 includes base stations (BSs) 102, user equipments (UEs) 104, one or more core networks, such as an Evolved Packet Core (EPC) 160 and 5G Core (5GC) network 190, which interoperate to provide wireless communications services.

BSs 102 may provide an access point to the EPC 160 and/or 5GC 190 for a UE 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. Base stations may include and/or be referred to as a gNB, NodeB, eNB, ng-eNB (e.g., an eNB that has been enhanced to provide connection to both EPC 160 and 5GC 190), an access point, a base transceiver station, a radio base station, a radio transceiver, or a transceiver function, or a transmission reception point in various contexts.

A BS, such as BS 102, may include components that are located at a single physical location or components located at various physical locations. In examples in which BS 102 includes components that are located at various physical locations, the various components may each perform various functions such that, collectively, the various components achieve functionality that is similar to a base station that is located at a single physical location. As such, a BS 102 may equivalently refer to a standalone BS or a BS including components that are located at various physical locations or virtualized locations. In some implementations, a BS 102 including components that are located at various physical locations may be referred to as or may be associated with a disaggregated radio access network (RAN) architecture, such as an Open RAN (O-RAN) or Virtualized RAN (VRAN) architecture. In some implementations, such components of a base station may include or refer to one or more of a central unit (CU), a distributed unit (DU), or a radio unit (RU).

BSs 102 wirelessly communicate with UEs 104 via communications links 120. Each of BSs 102 may provide communication coverage for a respective geographic coverage area 110, which may overlap in some cases. For example, small cell 102′ (e.g., a low-power base station) may have a coverage area 110′ that overlaps the coverage area 110 of one or more macrocells (e.g., high-power base stations).

The communication links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communication links 120 may use multiple-input and multiple-output (MIMO) antenna technology, including spatial multiplexing, beamforming, and/or transmit diversity in various aspects.

A UE may also be referred to as an access terminal, a terminal, a mobile station, a subscriber unit, a station, and/or the like. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IoT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

Some UEs may be considered as machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node (e.g., UE, BS, or the like) may provide, for example, connectivity for or to a network (e.g., a wide area network such as Internet or a cellular network) via a wired or wireless communication link. Some UEs may be considered as Internet-of-Things (IoT) devices, and/or may be implemented as NB-IoT (narrowband internet of things) devices. Some UEs may be considered as a Customer Premises Equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote unit (RU), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad, open-ended way. The example above where a UE is configured to receive information from a base station also discloses that a first network node is configured to receive information from a second network node, where the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first wireless node may be described as being configured to transmit information to a second wireless node. In this example and consistent with this disclosure, when the first wireless node is configured to transmit information to the second wireless node, the first wireless node may be configured to provide, send, output, communicate, or transmit information to the second wireless node. Similarly, in this example and consistent with this disclosure, when the first wireless node is configured to transmit information to the second wireless node, the second wireless node may be configured to receive, obtain, or decode the information that is provided, sent, output, communicated, or transmitted by the first wireless node.

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming.

In some cases, BS 180 may transmit a beamformed signal to UE 104 in one or more transmit directions 182′. UE 104 may receive the beamformed signal from BS 180 in one or more receive directions 182″. UE 104 may also transmit a beamformed signal to BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

As described in more detail elsewhere herein, a BS 102 may receive from one or more UEs 104, a plurality of random access preambles on a physical random access channel (PRACH), each random access preamble comprising the same random access preamble sequence. The BS 102 may then transmit to the one or more UEs 104, a response message indicating a pool of uplink (UL) resources. The BS 102 may further receive from the one or more UEs 104, one or more transmissions on a subset of the pool of uplink resources.

Accordingly, a UE 104 may transmit to a BS 102, a random access preamble on a PRACH, the random access preamble comprising a random access preamble sequence. The UE 104 may further receive from the BS 102, a response message indicating a pool of uplink (UL) resources. Then, the UE may randomly select a UL resource from the pool of UL resources and transmit to the BS 102, a transmission on the selected UL resource.

As indicated above, FIG. 1 is provided merely as an example. Other examples may differ from what is described with regards to FIG. 1.

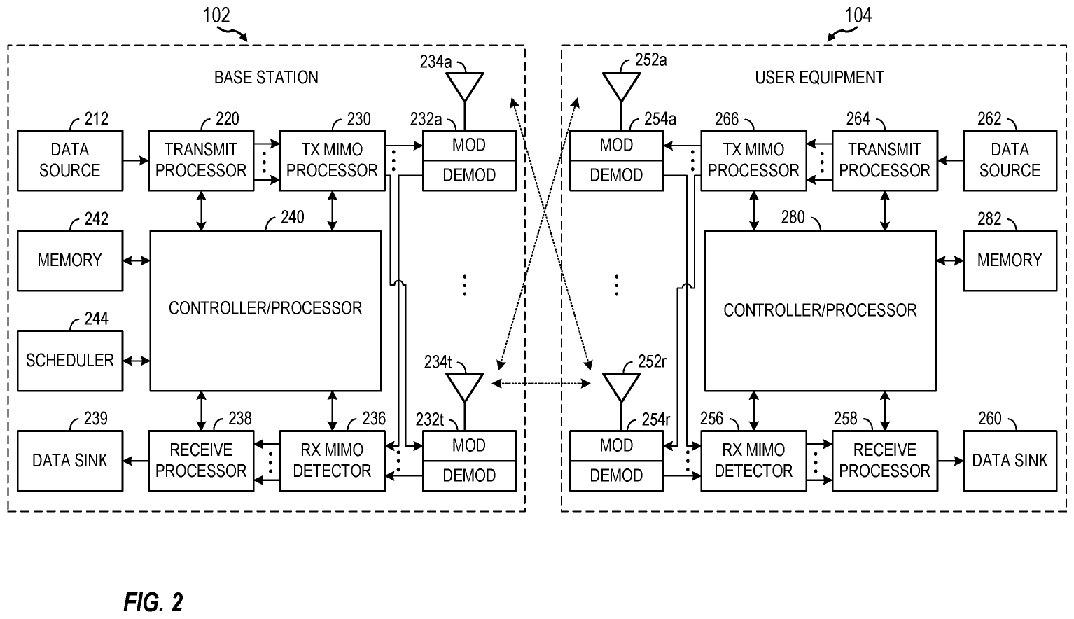

FIG. 2 depicts aspects of an example BS 102 and a UE 104. BS 102 may be equipped with T antennas 234a through 234t, and UE 104 may be equipped with R antennas 252a through 252r, where in general T≥1 and R≥1.

At BS 102, a transmit processor 220 may receive data from a data source 212 for one or more UEs, select one or more modulation and coding schemes (MCS) for each UE e.g., based on channel quality indicators (CQIs) received from the UE, process (e.g., encode and modulate) the data for each UE based on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (Tx) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators/demodulators (MODs/DEMODs) 232a through 232t. Each modulator/demodulator 232 (e.g., 232a through 232t) may modulate a respective output symbol stream (e.g., for OFDM and/or the like) to obtain an output sample stream. Each modulator/demodulator 232 may further modulate (e.g., convert to analog, amplify, filter, and upconvert) the output sample stream to obtain a downlink signal. T downlink signals from modulators/demodulators 232a through 232t may be transmitted via T antennas 234a through 234t, respectively.

At UE 104, antennas 252a through 252r may receive the downlink signals from base station 102 and/or other base stations and may provide received signals to modulators/demodulators (MODs/DEMODs) 254a through 254r, respectively. Each modulator/demodulator 254 (e.g., 254a through 254r) may condition (e.g., filter, amplify, downconvert, and digitize) a received signal to obtain input samples. Each modulator/demodulator 254 may further demodulate the input samples (e.g., for OFDM and/or the like) to obtain received symbols. A MIMO detector 256 may obtain received symbols from all R modulators/demodulators 254a through 254r, perform MIMO detection on the received symbols if applicable, and provide detected symbols. A receive processor 258 may process (e.g., demodulate and decode) the detected symbols, provide decoded data for UE 120a to a data sink 260, and provide decoded control information and system information to a controller/processor 280. A channel processor may identify reference signal received power (RSRP), received signal strength indicator (RSSI), reference signal received quality (RSRQ), channel quality indicator (CQI), and/or the like. In some aspects, one or more components of UE 120a and/or UE 120e may be included in a housing.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals. The symbols from transmit processor 264 may be precoded by a Tx MIMO processor 266 if applicable, modulated by modulators/demodulators 254a through 254r (e.g., for DFT-s-OFDM, CP-OFDM, and/or the like), and transmitted to base station 102 on the uplink.

At BS 102, the uplink signals from UE 104 and/or other UEs may be received by antennas 234 (e.g., 234a through 234t), demodulated by modulators/demodulators 232, detected by a MIMO detector 236 if applicable, and further processed by a receive processor 238 to obtain decoded data and control information sent by UE 104 and/or other UEs. Receive processor 238 may provide the decoded data to a data sink 239 and the decoded control information to controller/processor 240.

Generally, BS 102 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, BS 102 may send and receive data between itself and UE 104.

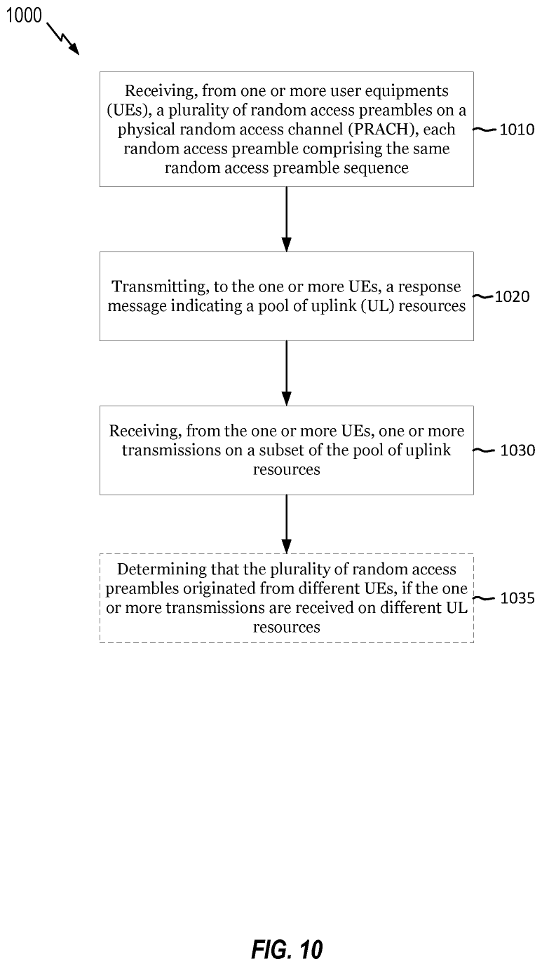

BS 102 includes controller/processor 240, which may be configured to implement various functions related to wireless communications. For example, the controller/processor 240 may be configured to receive from one or more UEs 104, a plurality of random access preambles on a physical random access channel (PRACH), each random access preamble comprising the same random access preamble sequence. The controller/processor 240 may be further configured to transmit to the one or more UEs 104, a response message indicating a pool of uplink (UL) resources. The controller/processor 240 may be further configured to receive from the one or more UEs 104, one or more transmissions on a subset of the pool of uplink resources. Further functions that may be implemented by controller/processor 240 of BS 102 are described with reference to FIG. 10 below.

In some aspects, a BS 102 may thus comprise means for receiving from one or more UEs 104, a plurality of random access preambles on a physical random access channel (PRACH), each random access preamble comprising the same random access preamble sequence. BS 102 may further comprise means for transmitting to the one or more UEs 104, a response message indicating a pool of uplink (UL) resources. BS 102 may further comprise means for receiving from the one or more UEs 104, one or more transmissions on a subset of the pool of uplink resources. In some aspects, the BS 102 may include means for carrying out the various techniques described with reference to FIG. 10 below.

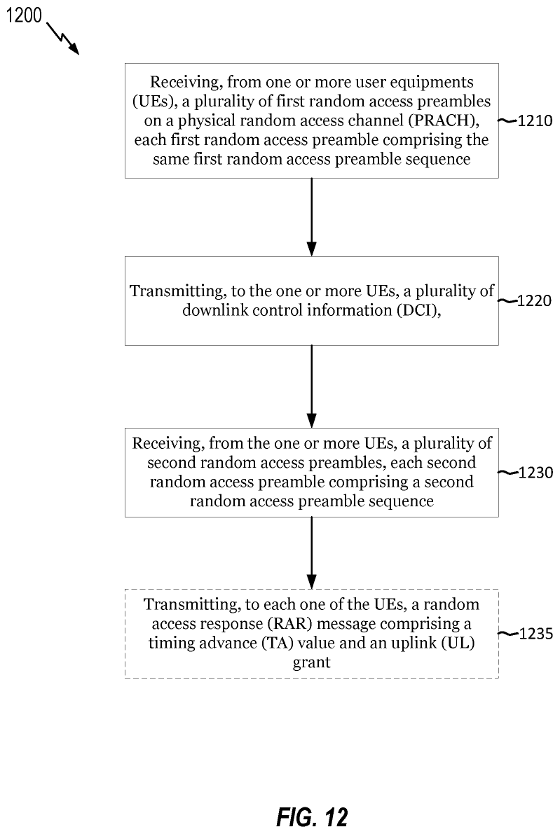

In some aspects of the present disclosure, controller/processor 240 may be configured to receive from one or more user equipments (UEs), a plurality of first random access preambles on a physical random access channel (PRACH), each first random access preamble comprising the same first random access preamble sequence. Controller/processor 240 may be further configured to transmit, to the one or more UEs, a plurality of downlink control information (DCI). Each DCI may comprise an indication of the first random access preamble sequence, an indication of a time, at which the first random access preamble was transmitted, and an indication to transmit a second random access preamble. Controller/processor 240 may be configured to receive, from the one or more UEs, a plurality of second random access preambles, each second random access preamble comprising a second random access preamble sequence. Further functions that may be implemented by controller/processor 240 of BS 102 are described with reference to FIG. 12 below

In some aspects, a BS 102 may thus comprise means for receiving from one or more user equipments (UEs), a plurality of first random access preambles on a physical random access channel (PRACH), each first random access preamble comprising the same first random access preamble sequence. BS 102 may further comprise means for transmitting, to the one or more UEs, a plurality of downlink control information (DCI). Each DCI may comprise an indication of the first random access preamble sequence, an indication of a time, at which the first random access preamble was transmitted, and an indication to transmit a second random access preamble. BS 102 may further comprise means for receiving, from the one or more UEs, a plurality of second random access preambles, each second random access preamble comprising a second random access preamble sequence. In some aspects, the BS 102 may include means for carrying out the various techniques described with reference to FIG. 12 below.

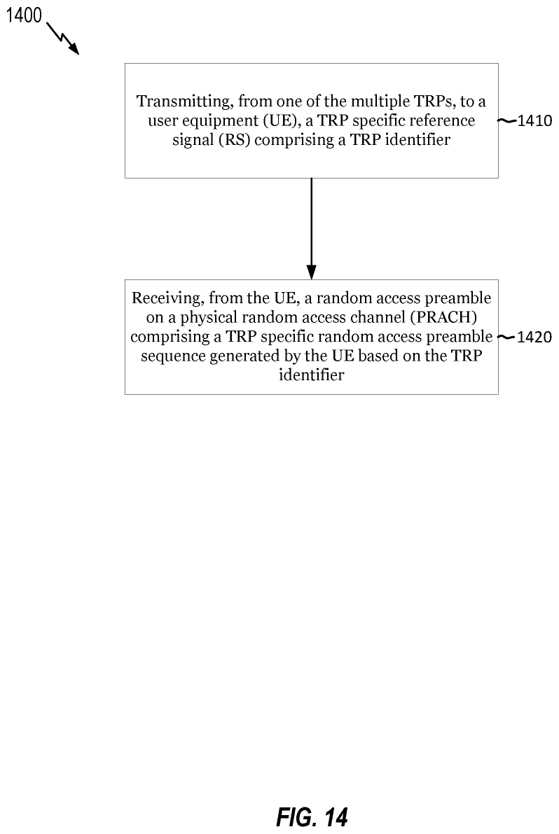

In some aspects of the present disclosure, controller/processor 240 may be configured to transmit, from one of multiple transmission reception points (TRPs), to a UE, a TRP specific reference signal (RS) comprising a TRP identifier. Controller/processor 240 may be configured to receive, from the UE, a random access preamble on a PRACH comprising a TRP specific random access preamble sequence generated by the UE based on the TRP identifier. Further functions that may be implemented by controller/processor 240 of BS 102 are described with reference to FIG. 14 below.

In some aspects, a BS 102 may thus comprise means for transmitting, from one of multiple TRPs, to a UE, a TRP specific reference signal (RS) comprising a TRP identifier. BS 102 may further comprise means for receiving, from the UE, a random access preamble on a PRACH comprising a TRP specific random access preamble sequence generated by the UE based on the TRP identifier. In some aspects, the BS 102 may include means for carrying out the various techniques described with reference to FIG. 14 below.

Generally, UE 104 includes various processors (e.g., 258, 264, 266, and 280), antennas 252a-r (collectively 252), transceivers 254a-r (collectively 254), which include modulators and demodulators, and other aspects, which enable wireless transmission of data (e.g., data source 262) and wireless reception of data (e.g., data sink 260).

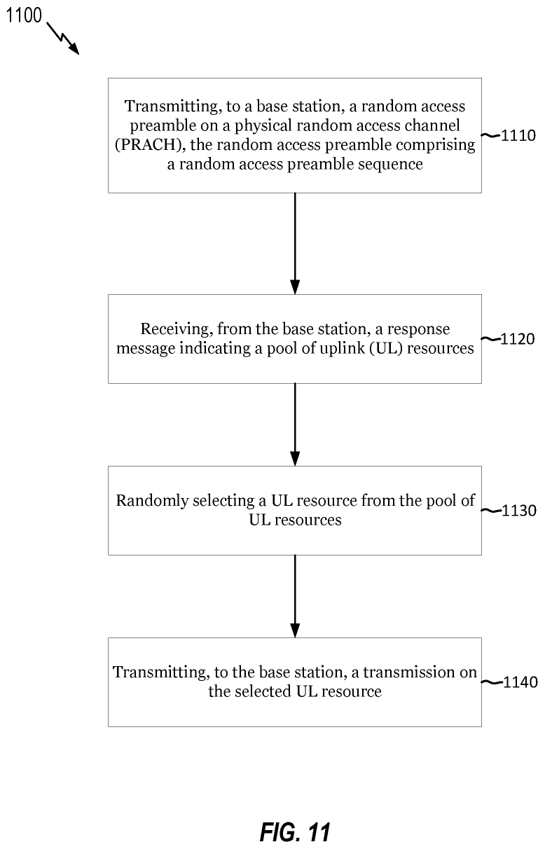

UE 104 includes controller/processor 280, which may be configured to implement various functions related to wireless communications. For example, the controller/processor 280 may be configured to transmit to BS 102, a random access preamble on a PRACH, the random access preamble comprising a random access preamble sequence. The controller/processor 280 may be further configured to receive from the BS 102, a response message indicating a pool of uplink (UL) resources. The controller/processor 280 may be further configured to randomly select a UL resource from the pool of UL resources and to transmit to the BS 102, a transmission on the selected UL resource. Further functions that may be implemented by controller/processor 280 of UE 104 are described with reference to FIG. 11 below.

In some aspects, a UE 104 may thus comprise means for transmitting to BS 102, a random access preamble on a PRACH, the random access preamble comprising a random access preamble sequence. UE 104 may further comprise means for receiving from the BS 102, a response message indicating a pool of uplink (UL) resources. UE 104 may further comprise means for randomly selecting a UL resource from the pool of UL resources and means for transmitting to the BS 102, a transmission on the selected UL resource. In some aspects, the UE 104 may include means for carrying out the various techniques described with reference to FIG. 11 below.

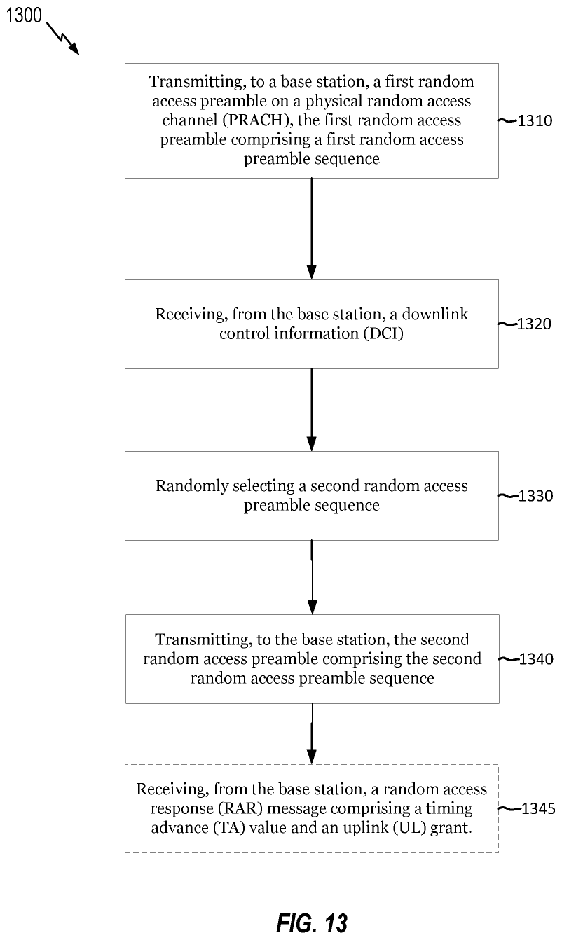

In some aspects of the present disclosure, controller/processor 280 may be configured to transmit, to a BS 102, a first random access preamble on a PRACH, the first random access preamble comprising a first random access preamble sequence. Controller/processor 280 may be further configured to receive, from the base station, a DCI. The DCI may comprise an indication of the first random access preamble sequence, an indication of a time, at which the random access preamble was transmitted, and an indication to transmit a second random access preamble. Controller/processor 280 may be further configured to randomly select a second random access preamble sequence and to transmit, to the base station, the second random access preamble comprising the second random access preamble sequence. Further functions that may be implemented by controller/processor 280 of UE 104 are described with reference to FIG. 13 below.

In some aspects, a UE 104 may thus comprise means for transmitting, to a BS 102, a first random access preamble on a PRACH, the first random access preamble comprising a first random access preamble sequence. UE 104 may further comprise means for receiving, from the base station, a DCI. The DCI may comprise an indication of the first random access preamble sequence, an indication of a time, at which the random access preamble was transmitted, and an indication to transmit a second random access preamble. UE 104 may further comprise means for randomly selecting a second random access preamble sequence and means for transmitting, to the base station, the second random access preamble comprising the second random access preamble sequence. In some aspects, the UE 104 may include means for carrying out the various techniques described with reference to FIG. 13 below.

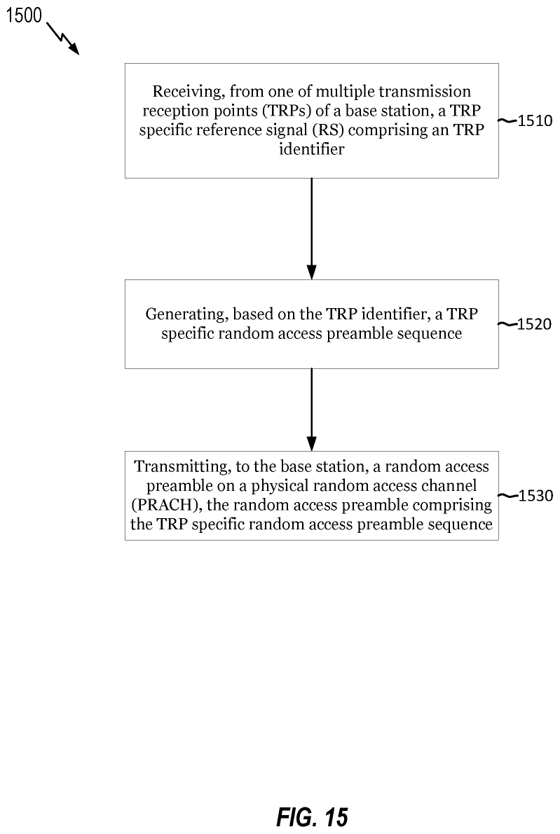

In some aspects of the present disclosure, controller/processor 280 may be configured to receive, from one of multiple TRPs of a base station, a TRP specific RS comprising an TRP identifier. Controller/processor 280 may be further configured to generate, based on the TRP identifier, a TRP specific random access preamble sequence. Controller/processor 280 may be further configured to transmit, to the base station, a random access preamble on a PRACH, the random access preamble comprising the TRP specific random access preamble sequence. Further functions that may be implemented by controller/processor 280 of UE 104 are described with reference to FIG. 15 below.

In some aspects, a UE 104 may thus comprise means for receiving, from one of multiple TRPs of a base station, a TRP specific RS comprising an TRP identifier. UE 104 may further comprise means for generating, based on the TRP identifier, a TRP specific random access preamble sequence. UE 104 may further comprise means for transmitting, to the base station, a random access preamble on a PRACH, the random access preamble comprising the TRP specific random access preamble sequence. In some aspects, the UE 104 may include means for carrying out the various techniques described with reference to FIG. 15 below.

As indicated above, FIG. 2 is provided merely as an example. Other examples may differ from what is described with regards to FIG. 2.

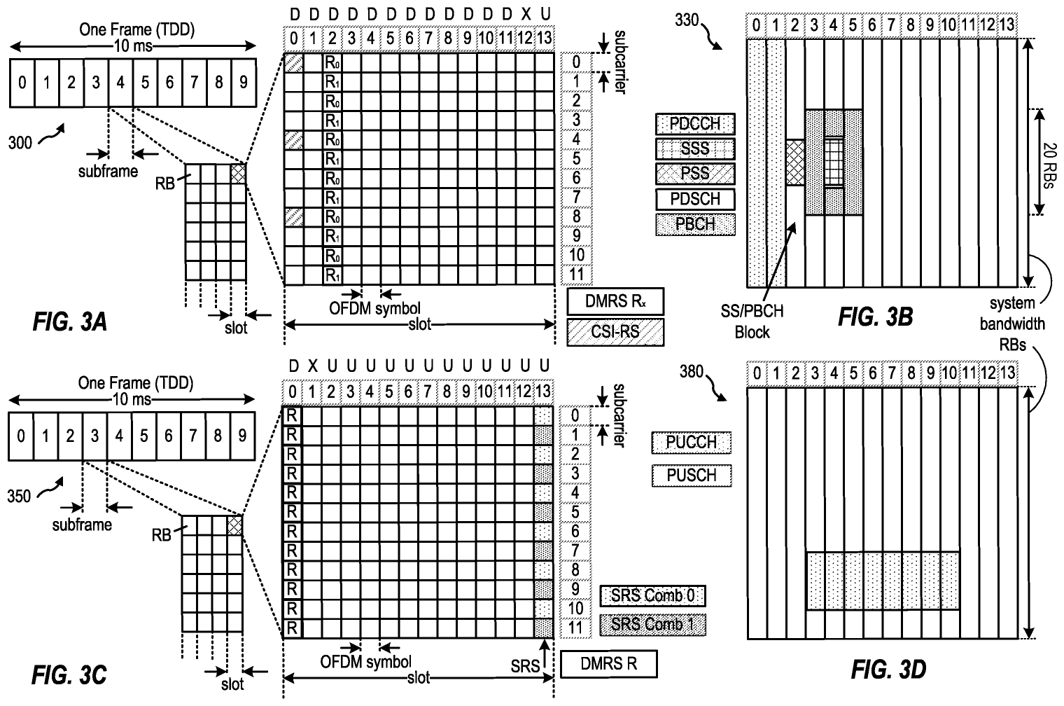

FIGS. 3A to 3D depict aspects of data structures for use in a wireless communication network, such as wireless communication network 100 of FIG. 1. In particular, FIG. 3A is a diagram 300 illustrating an example of a first subframe within a frame structure such as a 5G frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe may be based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2\hat{ }μ×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A, 3B, 3C, and 3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., UE 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

As indicated above, FIG. 3A to FIG. 3D are provided merely as an example. Other examples may differ from what is described with regards to FIG. 3A to FIG. 3D.

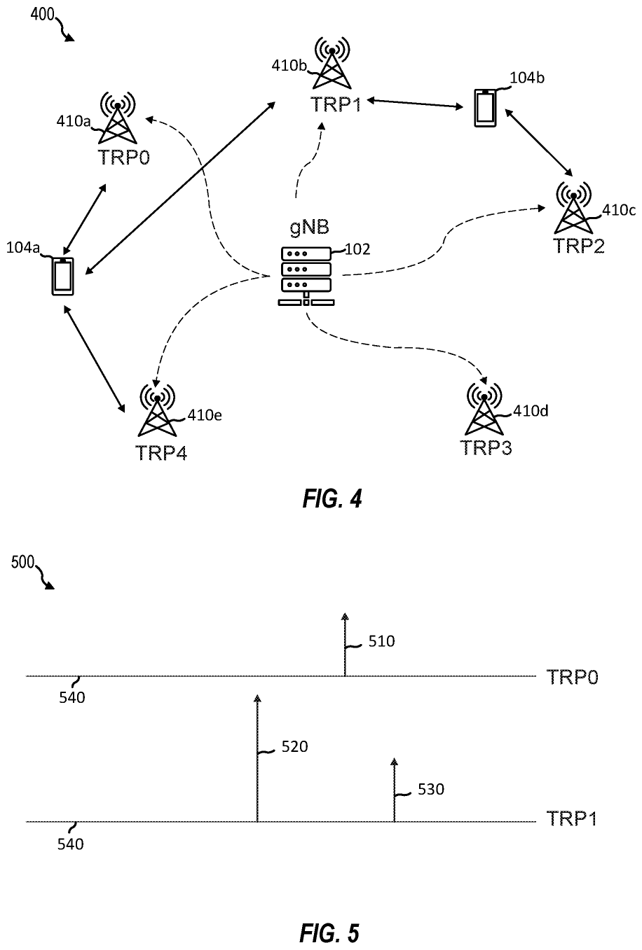

FIG. 4 is a block diagram illustrating an example of a base station (e.g., a 5G gNB) including/operating multiple transmission reception points (TRPs).

As is illustrated in the exemplary constellation 400 of FIG. 4, a base station 102 may communicate via multiple transmission reception points (TRPs) with a plurality of served UEs. In the example depicted in FIG. 4, the base station 102 includes/operates five TRPs 410a to 410e. However, other numbers of TRPs are possible. The use of multiple TRPs allows a base station to communicate to UEs through more than one transmission/reception unit. Thus, using multiple TRPs may allow an increase in efficiency of Multiple Input, Multiple Output (MIMO) communication by utilizing several beams/spatial streams for sending and receiving transmissions.

As is illustrated in FIG. 4, base station 102 may communicate with UE 104a through TRPs 410a, 410b and 410e. At the same time, base station 102 may communicate with UE 104b through TRPs 410b and 410c. Thus, each UE in the cell may communicate with multiple TRPs on UL and/or DL. Moreover, some TRPs may communicate with multiple UEs at the same time, as for example TRP 410b which communicates with both UE 104a and UE 104b.

Generally, multiple TRPs belonging to the same base station use the same cell ID which may lead to the same content in Remaining Minimum System Information (RMSI). For random access, this may lead to multiple UEs using the same PRACH sequence at the same or a similar time. Thus, one or more TRPs may detect the same set of PRACH sequences. As there is no prior knowledge if the detected PRACH sequences originate from a single UE or multiple UEs, this may lead to PRACH contention.

It is to be understood that the present disclosure is not limited to the case of base stations having multiple TRPs. The herein-described techniques for the resolution of PRACH contention are also applicable to one ore more base stations comprising only a single TRP.

As indicated above, FIG. 4 is provided merely as an example. Other examples may differ from what is described with regards to FIG. 4.

FIG. 5 is a diagram illustrating the reception of several identical random access preambles via two TRPs, in accordance with some aspects of the present disclosure.

The example 500 illustrated in FIG. 5 shows three random access preambles 510, 520 and 530, each containing the same PRACH sequences, that are received by a base station via two TRPs, namely TRP0 and TRP1. Random access preambles may sometimes also be denoted as “Msg1” or as “random access request”. As can be seen from FIG. 5, one random access preamble 510 is received via TRP0, while two random access preambles 520 and 530 are received via TRP1. The different lengths of the arrows indicate different signal strengths determined for the random access preambles. The timelines 540 indicate a timing offset of the received random access preambles relative to a reference timing of the base station. Because all three random access preambles may contain the same PRACH sequence, a base station cannot determine whether the random access preambles were sent from one, two or three UEs. In the case of a single UE, the BS may have received the same preamble over both TRP0 and TRP1, while the preamble received via TRP1 may have been transmitted via multiple paths, e.g., random access preamble 520 may have been transmitted directly and random access preamble 530 may have been transmitted via reflection off a reflecting surface/object. Alternatively, two UEs may have transmitted random access preambles, wherein one UE transmitted a random access preamble 520 only via TRP1, while another UE transmitted the random access preambles 510 and 530 over both TRP0 and TRP1. These constellations are only exemplary and other constellations are possible.

Due to different propagation delay to different TRPS, single random access preamble transmissions may arrive at the different TRPs at different timing offset. Furthermore, due to reception via multiple paths (e.g., by reflection of a surface), the same random access preamble may arrive at the same TRP at multiple timing offsets.

It is thus an object of the present disclosure to enable the BS to identify whether the random access preambles originate from one or from multiple UEs.

As indicated above, FIG. 5 is provided merely as an example. Other examples may differ from what is described with regards to FIG. 5.

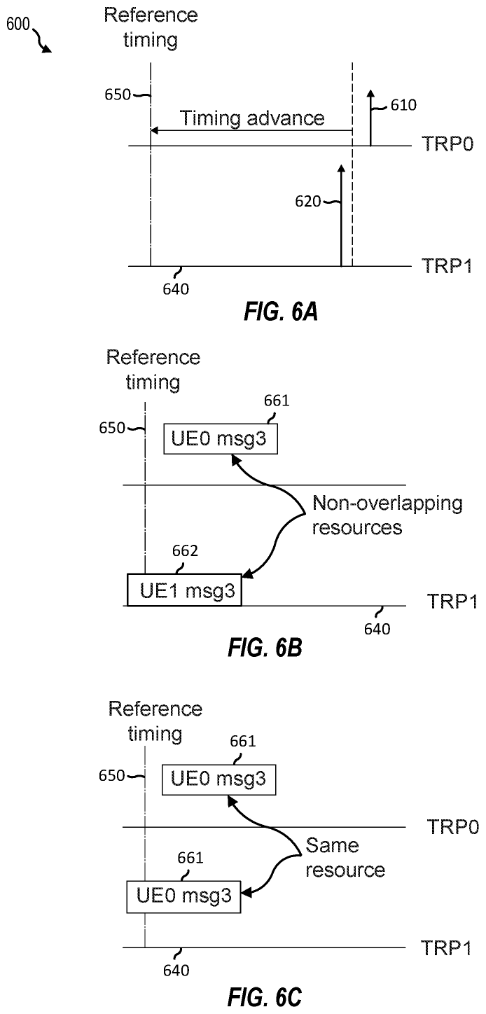

FIGS. 6A, 6B and 6C depict example aspects of PRACH contention resolution between two UEs with similar timing advance, in accordance with some aspects of the present disclosure.

As can be seen from example 600 in FIG. 6A, two TRPs may both receive a random access preamble, wherein both random access preambles 610 and 620 include the same PRACH sequence. As exemplary illustrated in FIG. 6A, TRP0 may receive random access preamble 610 and TRP1 may receive random access preamble 620. As further illustrated by FIG. 6A, both received random access preambles may correspond to similar timing offset relative to a reference timing 650 of the base station. This allows the base station to assign the same timing advance (TA) to both of the random access preambles 610 and 620.

If this is the case, the base station may as a next step send a response message, for example a random access response (RAR) message. A RAR message may sometimes be denoted as “Msg2”. In some aspects, the RAR message may comprise a pool of uplink (UL) resources, which in some aspects may comprise a plurality of UL grants, for example RAR UL grants for use by the UE(s) that transmitted the random access preambles 610 and 620.

A UE receiving the RAR messages including the pool of UL resources may then randomly select one of the UL resources from the pool of UL resources and may transmit a response to the RAR to the base station on the selected UL resource. Thus, if the random access preambles 610 and 620 originated from different UEs, different UEs will likely select different UL resources, thus resolving the contention as the base station receives the response to the RAR on different UL resources, as illustrated in FIG. 6B. In some aspects, the transmission may be a random access connection request, e.g., a RRC Connection request. A random access connection request may sometimes be denoted as “Msg3”.

In the case depicted in FIG. 6B, the base station receives the response to the RAR (e.g., msg3) on different resources. For example, the base station receives transmission 661 from UE0 on a first resource and transmission 662 from UE1 on a second non-overlapping UL transmission resource, e.g., on a different set of PREs of the 5G transmission grid. In this case, the base station may continue the PRACH process for each UE separately. I.e., a respective acknowledgement message (e.g., HARQ ACK) may be transmitted to each one of the UEs individually. In some cases, an acknowledgement message may also be denoted as “Msg4”.

If, on the other hand, both transmissions are received on the same resource, as illustrated in FIG. 6C, the base station may assume that the random access preamble originated from the same UE and proceed with the PRACH process accordingly. This still allows for some chance of collision in the transmission, however, the probability for collision is much lower due to the additional randomized selection of UL resources. For example, if the RAR comprises a pool of ten different UL resources and if the random selection probability is the same for all resources for both UEs contention is avoided in 90% of the cases. Thus, the base station may receive, from the UEs, a plurality of random access preambles on a PRACH, each random access preamble comprising the same random access preamble sequence. In response the base station may transmit to the UEs, a response message indicating a pool of UL resources; and may receive, from the UEs, a transmissions on a subset of the pool of UL resources.

The chance of success for this process strongly depends on the amount of UL resources assigned in the response message. If there are many UL resources assigned, the chance of further collision can be considerably decreased. However, given the limited availability of UL resources, the cost for decreasing the chance for collision may increase at the same time. Thus, the base station may decide what amount of UL resources to make available to the UE(s) based on the amount of available UL resources and/or prior knowledge on the probability of collision, e.g., by its knowledge of the overall base station occupancy or density of UEs in a cell.

As indicated above, FIG. 6 is provided merely as an example. Other examples may differ from what is described with regards to FIG. 6.

The contention resolution as described with reference to FIG. 6 is limited to the case that the random access preambles received by the base station correspond to the same or a similar TA value.

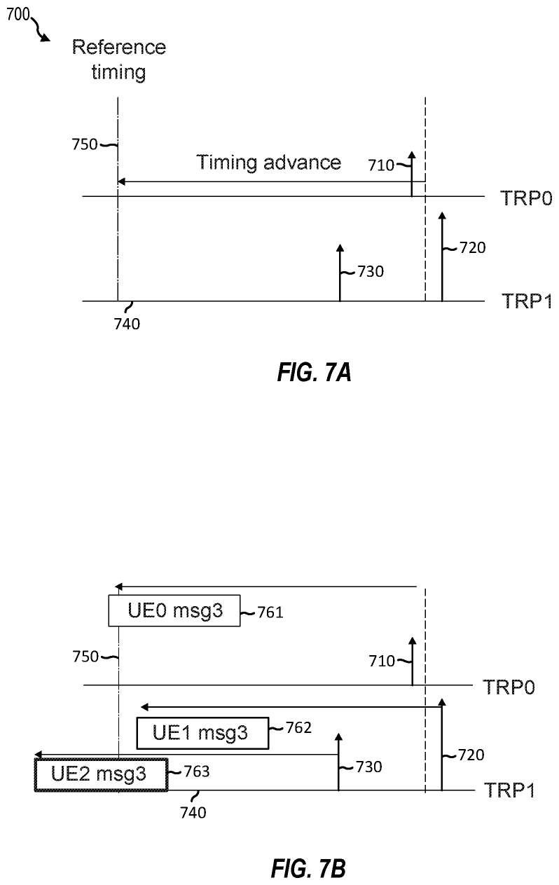

FIGS. 7A and 7B depict example aspects of PRACH contention resolution between three UEs with different timing advance (TA), in accordance with some aspects of the present disclosure.

As is illustrated in example 700 of FIG. 7A, the two received random access preambles 710 and 720 have similar timing offset from a reference timing 750 of the base station and can thus be addressed by a single TA value. At the same time, random access preamble 730 has a considerably smaller timing offset than random access preambles 710 and 720 and can thus not be addressed by the same TA value.

If the base station sets one TA value for UE0 and UE 1, transmissions 761 of UE0 and transmission 762 of UE1 may be successfully received by the base station, while transmission 763 of UE2 cannot be successfully received because the discrepancy between the timing offset and the configured TA value are too large, as is illustrated in FIG. 7B. In this case, the transmission 763 of UE2 is likely not decodable and thus, the PRACH process is likely to fail for UE2. Thus, contention resolution techniques as described with reference to FIG. 6 will succeed for UE0 and UE1 but may fail for UE2 due to a too large timing offset.

As indicated above, FIG. 7 is provided merely as an example. Other examples may differ from what is described with regards to FIG. 7.

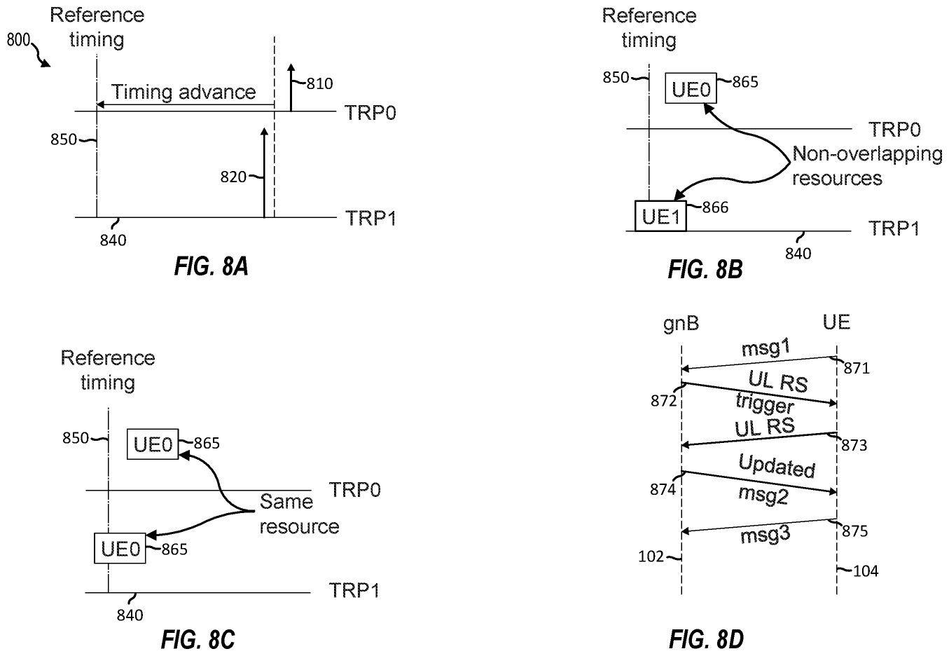

FIGS. 8A, 8B, 8C and 8D depict further example aspects of PRACH contention resolution between two UEs with similar timing advance, in accordance with some aspects of the present disclosure.

In example 800 as illustrated in FIG. 8A, two TRPs may both receive a random access preamble, both random access preambles including the same PRACH sequence. As exemplary illustrated in FIG. 8A, TRP0 may receive random access preamble 810 and TRP1 may receive random access preamble 820. As further illustrated by FIG. 8A, both received random access preambles may correspond to similar timing offset relative to a reference timing 850 of the base station. This allows the base station to assign the same timing advance (TA) to both of the random access preambles.

In order to determine if the random access preambles originate from the same or different UEs, the base station may transmit a downlink (DL) message to the UE(s) to provide multiple UL reference signal (RS) resources and to trigger a UL RS by the UE(s). Similar to the above embodiment, the UE(s) randomly select(s) one of the UL RS resources indicated by the DL message and transmit(s) a RS 865 on the selected UL RS resource.

In one example, the UL RSs may be transmitted on different resources. For example, UL RS 865 may be transmitted by UE0 on a first UL RS resource and UL RS 866 may be transmitted by UE1 on a second UL RS resource, as illustrated in FIG. 8B. In this manner, the base station may discriminate between the UEs and may transmit an updated response message to the UEs individually, to which the UEs may then respond by transmitting a random access connection request message without contention. The updated response message may be associated with the corresponding detected RS, such that the respective UE can detect that it is the rightful recipient of the updated response message.

Alternatively, if the UL RSs 865 are transmitted on the same UL RS resource, as illustrated in FIG. 8C, the base station may assume that the random access preamble originated from the same UE and proceed with the PRACH process accordingly. This still allows for some chance of collision in the transmission, however, the probability for collision is much lower due to the additional randomized selection of UL resources as discussed for FIG. 6A to FIG. 6C above.

Thus, the method as discussed in the present embodiment can be described as illustrated in FIG. 8D. Therein, UE 104 may transmit a random access preamble (msg1) 871 to base station 102. In response, the base station 102 may transmit a UL RS trigger 872 providing multiple UL RS resources. After randomly selecting one of the multiple UL RS resources, the UE 104 may then transmit a UL RS 873 on the selected UL RS resource. In response, the base station 102 may transmit an updated response message (msg2) 874 to UE 104. Consequently, the UE may transmit the random access connection request message (msg3) 875.

In some aspects, the UL RS 873 may be a Sounding RS (SRS). A pool of SRS resources may be preconfigured for the UE by RMSI. The UE may then randomly select an SRS resource from the preconfigured pool to transmit the SRS.

In some aspects, the UL RS trigger 872 may comprise a Media Access Control Control Element (MAC-CE) and/or Downlink Control Information (DCI). The UL RS trigger 872 may provide additional control on the preconfigured UL RS resources, i.e., it may further specify a subset of the pool of preconfigured UL RS resources. If DCI are used to trigger the UL RS, the field of the DCI which is reserved for PDSCH may be used to carry a TA value, because no PDSCH needs to be transmitted with this DCI.

Because RSs require less overhead than a random access connection request, it may be advantageous to use the method of the embodiment described with reference to FIGS. 8A to 8D rather than the embodiment described with reference to 6A to 6C, because this way valuable UL resources that might be wasted with an unsuccessful Msg3-transmission can be saved.

Furthermore, in the presence of the same amount of physical resources, using SRS instead of Msg3-transmissions provides more possible dimensions and thus allows for discrimination of more UEs at the same time.

On the other hand, the embodiment described with reference to FIGS. 8A to 8D requires two further transmissions that would not be necessary with the embodiment described with reference to FIGS. 6A to 6C. Thus, if a sufficient amount of UL resources are available, the transmission of multiple UL grants for Msg3-transmissions may in some cases be more efficient than the triggering and transmission of an additional RS. In some aspects, a base station may thus dynamically decide whether the contention resolution technique of FIG. 6A to 6C or the technique of FIG. 8A to 8D is better suited for a given cell occupancy. In both cases, a base station may receive, from one or more UEs, a plurality of random access preambles on PRACH and may transmit, to the one or more UEs, a response message indicating a pool UL resources, and may receive, from the one or more UEs, one or more transmissions on a subset of the pool of UL resources as discussed in more detail with reference to FIG. 10 and FIG. 11 below.

As indicated above, FIG. 8 is provided merely as an example. Other examples may differ from what is described with regards to FIG. 8.

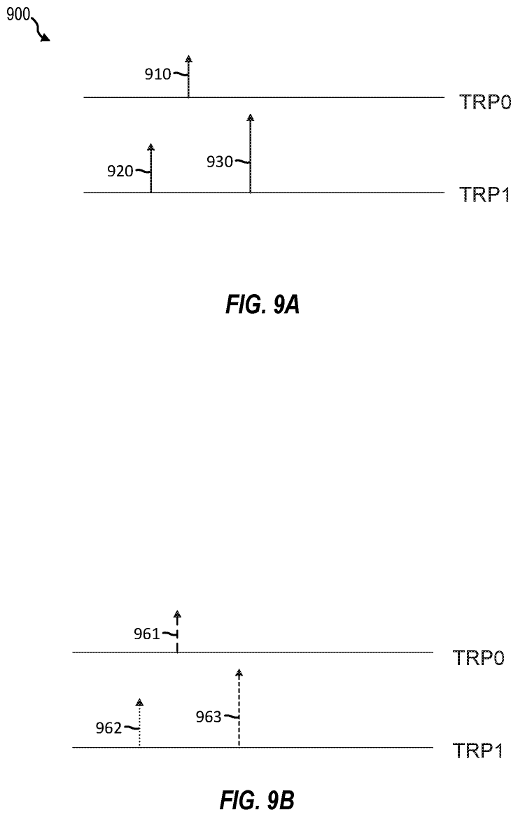

FIGS. 9A and 9B depict further example aspects of PRACH contention resolution between multiple UEs, in accordance with some aspects of the present disclosure.

In the example configuration 900 as illustrated in FIG. 9, multiple first random access preambles 910, 920 and 930 containing the same PRACH sequences might be received at the same or similar time but with different timing offsets from a reference timing of the base station, such that it is not possible to apply the same TA value for all of the received random access preambles. In this case, the base station may transmit a DCI to the UE(s) indicating to the UE(s) that they should transmit another random access preamble comprising another PRACH sequence. The DCI may indicate a second pool of PRACH sequences different from a first pool of PRACH sequences that is predefined for the base station. The DCI may comprise an indication of the first PRACH sequence, an indication of a time, at which the first random access preamble was transmitted, and an indication to transmit a second random access preamble. This way, each UE may know that it is the intended recipient of the DCI. In this manner, the potential interference/contention discussed with reference to FIG. 7 above can be addressed.

In response to the DCI, each UE may randomly select a second PRACH sequence from the second pool of PRACH sequences and may thus retransmit a second random access preamble comprising the second PRACH sequence. In this manner, a first UE may transmit random access preamble 961, while a second UE transmits random access preamble 962 and a third UE transmits random access preamble 963, likely all comprising different PRACH sequences. This way, the three UEs are distinguishable to the base station, and three separate random access processes can be initiated. Thus, separate calculation of TA values becomes possible for the base station. The base station may then transmit a RAR message comprising a TA value and an UL grant.

By transmitting a DCI instead of a Msg2-transmission, radio resources may be conserved, because the unnecessary transmission of a Msg3-transmission of all three UEs is omitted. Furthermore, the random access process is reinitiated faster than if the error occurs after unsuccessful transmission of Msg3, such that latency may also be reduced.

In some aspects, the DCI may be transmitted in a Type 1 search space together with a RAR DCI. In some aspects, the DCI may comprise an indication not to boost power for transmitting the second random access preamble. This way, energy may be conserved and the battery life of a UE may be improved.

As indicated above, FIG. 9 is provided merely as an example. Other examples may differ from what is described with regards to FIG. 9.

FIG. 10 is a flow chart illustrating an example of a process of wireless communication by a BS, in accordance with some aspects of the present disclosure. According to FIG. 10, a method 1000 for wireless communication may comprise receiving, from one or more user equipments (UEs), a plurality of random access preambles on a physical random access channel (PRACH), each random access preamble comprising the same random access preamble sequence (block 1010).

As is further shown in FIG. 10, the method 1000 for wireless communication may comprise transmitting, to the one or more UEs, a response message indicating a pool of uplink (UL) resources (block 1020).

This allows a UE receiving the plurality of UL grants to randomly select one of the UL grants. Thus, if the multiple random access preambles originated from multiple UEs, with high probability they will select different UL resources, thus resolving the contention as the base station receives a transmission on different resources.

In some aspects, the response message may be a random access response (RAR) message and the pool of UL resources may comprise a plurality of UL grants.

Because the UL grants may be used by a UE to send a response to the RAR (e.g., a Msg3-transmission) directly, this further increases efficiency of the random access process, because no further transmissions are necessary and full reinitiating of the random access process can be avoided.

In some aspects, the response message may trigger transmission of a UL reference signal (RS), and the pool of UL resources may comprise a pool of UL RS resources. In some aspects, the one or more transmissions may comprise one or more UL RSs.

Because transmitting a RSs generally require less overhead, this allows for a more efficient use of available radio resources.

As is further shown by FIG. 10, the method 1000 for wireless communication may comprise receiving, from the one or more UEs, one or more transmissions on a subset of the pool of uplink resources (block 1030).

This allows the base station to discriminate between different UEs.

In some aspects, the method 100 may further comprise determining that the plurality of random access preambles originated from different UEs, if the one or more transmissions are received on different UL resources (block 1035).

In some aspects, the received one or more transmissions comprise one or more connection request messages.

In some aspects, the method 1000 may further comprise transmitting, to the one or more UEs, based on the received one or more UL RS, one or more random access response (RAR) messages. Each RAR message may indicate a different UL grant.

This allows for enhanced efficiency and reduced latency in the random access procedure, because the full reinitiating of the random access procedure is omitted.

In some aspects, the pool of UL resources may be a subset of a default pool of resources which may be preconfigured by remaining minimum system information (RMSI).

Using the resources that have already been configured in RMSI allows for a more efficient usage of available radio resources.

In some aspects, the response message may comprise downlink control information (DCI).

In some aspects, the DCI may comprise, in a field related to a physical downlink shared channel (PDSCH), timing advance (TA) information of a TA applied to the pool of UL resources.

Using an available field in the DCI that is not required otherwise allows for a more efficient use of radio resources and may also increase battery life of a UE.

In some aspects, the base station may comprise a plurality of transmission reception points (TRPs) and the plurality of random access preambles may be received at different ones of the plurality of TRPs.

As indicated above, FIG. 10 is provided merely as an example. Other examples may differ from what is described with regards to FIG. 10.

FIG. 11 is a flow chart illustrating an example of a process of wireless communication by a UE, in accordance with some aspects of the present disclosure.

According to FIG. 11, a method 1100 for wireless communication may comprise transmitting, to a base station, a random access preamble on a physical random access channel (PRACH), the random access preamble comprising a random access preamble sequence (block 1110).

As is further shown by FIG. 11, the method 1100 for wireless communication may comprise receiving, from the base station, a response message indicating a pool of uplink (UL) resources (block 1120).

This allows the UE to randomly select one of the UL grants. Thus, if multiple random access preambles originated from multiple UEs, with high probability they will select different UL resources, thus resolving the contention as the base station receives a second transmission on different resources.

In some aspects, the response message may be a random access response (RAR) message and the pool of UL resources may comprise a plurality of UL grants.

Because the UL grants may be used by the UE to send a Msg3-transmission directly, this further increases efficiency of the random access process, because no further transmissions are necessary and full reinitiating of the random access process can be avoided.

As is further shown by FIG. 11, the method 1100 for wireless communication may comprise randomly selecting a UL resource from the pool of UL resources (block 1130).

The random selection allows for distinction of multiple UEs having sent the same random access preamble sequence. This increases the probability for successful contention resolution.

In some aspects, the response message may trigger transmission of a UL reference signal (RS), and the pool of UL resources may comprise a pool of UL RS resources. In some aspects, the one or more transmissions may comprise one or more UL RS.

Because RSs generally require less overhead, this allows for a more efficient use of available radio resources.

In some aspects, the method 1100 may further comprise receiving, from the base station, based on the received one or more UL RS, a random access response (RAR) message indicating a different UL grant.

In some aspects, the pool of UL resources may be a subset of a default pool of resources which may be preconfigured by remaining minimum system information (RMSI).

Using the resources that have already been configured in RMSI allows for a more efficient usage of available radio resources.

In some aspects, the response message may comprise downlink control information (DCI).

In some aspects, the DCI may comprise, in a field related to a physical downlink shared channel (PDSCH), timing advance (TA) information of a TA applied to the pool of UL resources.

Using an available field in the DCI that is not required otherwise allows for a more efficient use of radio resources and may also increase battery life of a UE.

As is further shown by FIG. 11, the method 1100 for wireless communication may comprise transmitting, to the base station, a transmission on the selected UL resource.

In some aspects, the transmission may comprise a connection request message.

In some aspects, the base station may comprise a plurality of transmission reception points (TRPs) and the plurality of random access preamble may be transmitted over different ones of the plurality of TRPs.

As indicated above, FIG. 11 is provided merely as an example. Other examples may differ from what is described with regards to FIG. 11.

FIG. 12 is a flow chart illustrating an example of a process of wireless communication by a BS, in accordance with some aspects of the present disclosure.

According to FIG. 12, a method 1200 for wireless communication may comprise receiving, from one or more user equipments (UEs), a plurality of first random access preambles on a physical random access channel (PRACH), each first random access preamble comprising the same first random access preamble sequence (block 1210).

As is further shown by FIG. 12, the method 1200 for wireless communication may comprise transmitting, to the one or more UEs, a plurality of downlink control information (DCI) (block 1220).

By transmitting a DCI instead of a Msg2-transmission, radio resources may be conserved, because the unnecessary transmission of a Msg3-transmission of multiple UEs is omitted. Furthermore, the random access process is reinitiated faster than if the error occurs after unsuccessful transmission of Msg3, such that latency may also be reduced.

In some aspects, each DCI may comprise an indication of the first random access preamble sequence, an indication of a time, at which the first random access preamble was transmitted, and an indication to transmit a second random access preamble.

This way, each UE knows that it is the intended recipient of the respective DCI.

In some aspects, the DCI may further comprises an indication not to boost power for transmitting the second random access preamble.

This allows the conservation of energy and improvement of the battery life of a UE.

As is further shown by FIG. 12, the method 1200 for wireless communication may comprise receiving, from the one or more UEs, a plurality of second random access preambles, each second random access preamble comprising a second random access preamble sequence (block 1230).

Thus, multiple UEs that at first transmitted the same random access preamble sequence become distinguishable to the base station, and separate random access processes for each UE can be initiated.

In some aspects, the method 1200 may further comprise transmitting, to each one of the UEs, a random access response (RAR) message comprising a timing advance (TA) value and an uplink (UL) grant (block 1235).

This allows for a more efficient use of radio resources because a full reinitiating of the random access procedure can be omitted.

As indicated above, FIG. 12 is provided merely as an example. Other examples may differ from what is described with regards to FIG. 12.

FIG. 13 is a flow chart illustrating an example of a process of wireless communication by a UE, in accordance with some aspects of the present disclosure.

According to FIG. 13, a method 1300 for wireless communication may comprise transmitting, to a base station, a first random access preamble on a physical random access channel (PRACH), the first random access preamble comprising a first random access preamble sequence (block 1310).

As is further shown by FIG. 13, the method 1300 for wireless communication may comprise receiving, from the base station, a downlink control information (DCI) (block 1320).

By transmitting a DCI instead of a Msg2-transmission, radio resources may be conserved, because the unnecessary transmission of a Msg3-transmission of multiple UEs is omitted. Furthermore, the random access process is reinitiated faster than if the error occurs after unsuccessful transmission of Msg3, such that latency may also be reduced.

In some aspects, the DCI may comprise an indication of the first random access preamble sequence, an indication of a time, at which the first random access preamble was transmitted, and an indication to transmit a second random access preamble.

This way, each UE knows that it is the intended recipient of the respective DCI.

In some aspects, the DCI may further comprise an indication not to boost power for transmitting the second random access preamble.

This allows the conservation of energy and improvement of the battery life of the UE.

As is further shown by FIG. 13, the method 1300 for wireless communication may comprise randomly selecting a second random access preamble sequence (block 1330).

The random selection allows for distinction of multiple UEs having sent the same random access preamble sequence. This increases the probability for successful contention resolution.

In some aspects, selecting the second random access preamble sequence may comprise selecting the second random access preamble sequence from a dedicated pool of random access preamble sequences that are not used for initial random access preambles.

As is further shown by FIG. 13, the method 1300 for wireless communication may comprise transmitting, to the base station, the second random access preamble comprising the second random access preamble sequence (block 1340).

In some aspects, the method 1300 may further comprise receiving, from the base station, a random access response (RAR) message comprising a timing advance (TA) value and an uplink (UL) grant (block 1345).

This allows for a more efficient use of radio resources because a full reinitiating of the random access procedure can be omitted.

As indicated above, FIG. 13 is provided merely as an example. Other examples may differ from what is described with regards to FIG. 13.

FIG. 14 is a flow chart illustrating an example of a process of wireless communication by a BS comprising multiple TRPs, in accordance with some aspects of the present disclosure.

According to FIG. 14, a method 1400 for wireless communication may comprise transmitting, from one of the multiple TRPs, to a user equipment (UE), a TRP specific reference signal (RS) comprising a TRP identifier (block 1410).

As is further shown by FIG. 14, the method 1400 for wireless communication may comprise receiving, from the UE, a random access preamble on a physical random access channel (PRACH) comprising a TRP specific random access preamble sequence generated by the UE based on the TRP identifier (block 1420).

The transmission of a TRP identifier allows for the distinction in the case of multiple TRPs sharing the same cell ID. This way, when a UE transmits a random access preamble, the random access preamble sequence may be generated based on the TRP identifier. This way, contention between multiple random access preambles received over multiple TRPs can be resolved.

In some aspects, there may be mapping from a RS comprising a TRP identifier to specific resources on a RACH.

This allows a UE to transmit the random access preamble on a TRP specific RACH resource. Therefore, the collision of random access preambles received over multiple TRPs can be avoided.

In some aspects, the TRP specific RS may be transmitted to the UE in remaining minimum system information (RMSI).

In some aspects, the TRP specific RS may be transmitted on top of a synchronization signal block (SSB).

This allows a UE to receive the TRP identifier upon initial access and may thus decrease the amount of time necessary for connection setup.

As indicated above, FIG. 14 is provided merely as an example. Other examples may differ from what is described with regards to FIG. 14.

FIG. 15 is a flow chart illustrating an example of a process of wireless communication by a UE, in accordance with some aspects of the present disclosure.

According to FIG. 15, a method 1500 for wireless communication may comprise receiving, from one of multiple transmission reception points (TRPs) of a base station, a TRP specific reference signal (RS) comprising an TRP identifier (block 1510).

As is further shown by FIG. 15, the method 1500 for wireless communication may comprise generating, based on the TRP identifier, a TRP specific random access preamble sequence (block 1520).

As is further shown by FIG. 15, the method 1500 for wireless communication may comprise transmitting, to the base station, a random access preamble on a physical random access channel (PRACH), the random access preamble comprising the TRP specific random access preamble sequence (block 1530).

The transmission of a TRP identifier allows for the distinction in the case of multiple TRPs sharing the same cell ID. This way, when the UE transmits a random access preamble, the random access preamble sequence may be generated based on the TRP identifier. This way, contention between multiple random access preambles received over multiple TRPs can be resolved.

In some aspects, there may be mapping from a RS comprising a TRP identifier to specific resources on a RACH.

This allows the UE to transmit the random access preamble on a TRP specific RACH resource. Therefore, the collision of random access preambles received over multiple TRPs can be avoided.

In some aspects, the TRP specific RS may be transmitted to the UE in remaining minimum system information (RMSI).

In some aspects, the TRP specific RS may be transmitted on top of a synchronization signal block (SSB).

This allows the UE to receive the TRP identifier upon initial access and may thus decrease the amount of time necessary for connection setup.

As indicated above, FIG. 15 is provided merely as an example. Other examples may differ from what is described with regards to FIG. 15.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software.

In the following, several further aspects of the present disclosure are presented:
Aspect 1. A method of wireless communication at a base station, comprising: receiving, from one or more user equipments (UEs), a plurality of random access preambles on a physical random access channel (PRACH), each random access preamble comprising the same random access preamble sequence; transmitting, to the one or more UEs, a response message indicating a pool of uplink (UL) resources; and receiving, from the one or more UEs, one or more transmissions on a subset of the pool of UL resources.
Aspect 2. The method of aspect 1, further comprising: determining that the plurality of random access preambles originated from different UEs, if the one or more transmissions are received on different UL resources.
Aspect 3. The method of any one of aspects 1 and 2, wherein the response message is a random access response (RAR) message and the pool of UL resources comprises a plurality of UL grants.
Aspect 4. The method of aspect 3, wherein the received one or more transmissions comprise one or more connection request messages.
Aspect 5. The method of any one of aspects 1 and 2, wherein the response message triggers transmission of a UL reference signal (RS), and the pool of UL resources comprises a pool of UL RS resources; and wherein the one or more transmissions comprise one or more UL RSs.
Aspect 6. The method of aspect 5, further comprising: transmitting, to the one or more UEs, based on the received one or more UL RS, one or more random access response (RAR) messages, each RAR message indicating a different UL grant.
Aspect 7. The method of any one of aspects 5 or 6, wherein the pool of UL resources is a subset of a default pool of resources which is preconfigured by remaining minimum system information (RMSI).
Aspect 8. The method of any one of aspects 5 to 7, wherein the response message comprises downlink control information (DCI).
Aspect 9. The method of aspect 8, wherein the DCI comprises, in a field related to a physical downlink shared channel (PDSCH), timing advance (TA) information of a TA applied to the pool of UL resources.
Aspect 10. The method of any one of the preceding aspects 1 to 9, wherein the base station comprises a plurality of transmission reception points (TRPs) and the plurality of random access preambles are received at different ones of the plurality of TRPs.
Aspect 11. A method for wireless communication at a user equipment (UE), comprising: transmitting, to a base station, a random access preamble on a physical random access channel (PRACH), the random access preamble comprising a random access preamble sequence; receiving, from the base station, a response message indicating a pool of uplink (UL) resources; randomly selecting a UL resource from the pool of UL resources; and transmitting, to the base station, a transmission on the selected UL resource.
Aspect 12. The method of aspect 11, wherein the response message is a random access response (RAR) message and the pool of UL resources comprises a plurality of UL grants.
Aspect 13. The method of aspect 12, wherein the transmission comprises a connection request message.
Aspect 14. The method of aspect 11, wherein the response message triggers transmission of a UL reference signal (RS), and the pool of UL resources comprises a pool of UL RS resources; and wherein the one or more transmissions comprise one or more UL RS.
Aspect 15. The method of aspect 14, further comprising: receiving, from the base station, based on the received one or more UL RS, a random access response (RAR) message indicating a different UL grant.
Aspect 16. The method of any one of aspects 14 or 15, wherein the pool of UL resources is a subset of a default pool of resources which is preconfigured by remaining minimum system information (RMSI).
Aspect 17. The method of any one of aspects 14 to 16, wherein the response message comprises downlink control information (DCI).
Aspect 18. The method of aspect 17, wherein the DCI comprises, in a field related to a physical downlink shared channel (PDSCH), timing advance (TA) information of a TA applied to the pool of UL resources.
Aspect 19. The method of any one of aspects 11 to 18, wherein the base station comprises a plurality of transmission reception points (TRPs) and the plurality of random access preamble are transmitted over different ones of the plurality of TRPs.
Aspect 20. A method for wireless communication by a base station, comprising: receiving, from one or more user equipments (UEs), a plurality of first random access preambles on a physical random access channel (PRACH), each first random access preamble comprising the same first random access preamble sequence; transmitting, to the one or more UEs, a plurality of downlink control information (DCI), each DCI comprising: an indication of the first random access preamble sequence, an indication of a time, at which the first random access preamble was transmitted, and an indication to transmit a second random access preamble; and receiving, from the one or more UEs, a plurality of second random access preambles, each second random access preamble comprising a second random access preamble sequence.
Aspect 21. The method of aspect 20, the method further comprising: transmitting, to each one of the UEs, a random access response (RAR) message comprising a timing advance (TA) value and an uplink (UL) grant.
Aspect 22. The method of any one of aspects 20 or 21, wherein the DCI further comprises an indication not to boost power for transmitting the second random access preamble.
Aspect 23. A method for wireless communication by a user equipment (UE), comprising: transmitting, to a base station, a first random access preamble on a physical random access channel (PRACH), the first random access preamble comprising a first random access preamble sequence; receiving, from the base station, a downlink control information (DCI) comprising: an indication of the first random access preamble sequence, an indication of a time, at which the random access preamble was transmitted, and an indication to transmit a second random access preamble; and randomly selecting a second random access preamble sequence; and transmitting, to the base station, the second random access preamble comprising the second random access preamble sequence.
Aspect 24. The method of aspect 23, the method further comprising: receiving, from the base station, a random access response (RAR) message comprising a timing advance (TA) value and an uplink (UL) grant.
Aspect 25. The method of any one of aspects 23 or 24, wherein the DCI further comprises an indication not to boost power for transmitting the second random access preamble.
Aspect 26. The method of any one of aspects 23 to 25, wherein selecting the second random access preamble sequence comprises: selecting the second random access preamble sequence from a dedicated pool of random access preamble sequences that are not used for initial random access preambles.
Aspect 27. A method for wireless communication at a base station comprising multiple transmission reception points (TRPs), the method comprising: transmitting, from one of the multiple TRPs, to a user equipment (UE), a TRP specific reference signal (RS) comprising a TRP identifier; receiving, from the UE, a random access preamble on a physical random access channel (PRACH) comprising a TRP specific random access preamble sequence generated by the UE based on the TRP identifier.
Aspect 28. The method of aspect 27, wherein the TRP specific RS is transmitted to the UE in remaining minimum system information (RMSI).
Aspect 29. The method of aspect 27, wherein the TRP specific RS is transmitted on top of a synchronization signal block (SSB).
Aspect 30. A method for wireless communication at a user equipment (UE), comprising: receiving, from one of multiple transmission reception points (TRPs) of a base station, a TRP specific reference signal (RS) comprising an TRP identifier; generating, based on the TRP identifier, a TRP specific random access preamble sequence; transmitting, to the base station, a random access preamble on a physical random access channel (PRACH), the random access preamble comprising the TRP specific random access preamble sequence.
Aspect 31. The method of aspect 30, wherein the TRP specific RS is received from the base station in remaining minimum system information (RMSI).
Aspect 32. The method of aspect 30, wherein the TRP specific RS is received on top of a synchronization signal block (SSB).
Aspect 33. An apparatus comprising at least one processor and a memory coupled to the at least one processor, the at least one processor being configured to perform any of the methods of aspects 1 to 10.
Aspect 34. An apparatus comprising at least one processor and a memory coupled to the at least one processor, the at least one processor being configured to perform any of the methods of aspects 11 to 19.
Aspect 35. An apparatus comprising at least one processor and a memory coupled to the at least one processor, the at least one processor being configured to perform any of the methods of aspects 20 to 22.
Aspect 36. An apparatus comprising at least one processor and a memory coupled to the at least one processor, the at least one processor being configured to perform any of the methods of aspects 23 to 26.
Aspect 37. An apparatus comprising at least one processor and a memory coupled to the at least one processor, the at least one processor being configured to perform any of the methods of aspects 27 to 29.
Aspect 38. An apparatus comprising at least one processor and a memory coupled to the at least one processor, the at least one processor being configured to perform any of the methods of aspects 30 to 32.
Aspect 39. An apparatus comprising means for performing any of the methods of aspects 1 to 10.
Aspect 40. An apparatus comprising means for performing any of the methods of aspects 11 to 19.
Aspect 41. An apparatus comprising means for performing any of the methods of aspects 20 to 22.
Aspect 42. An apparatus comprising means for performing any of the methods of aspects 23 to 26.
Aspect 43. An apparatus comprising means for performing any of the methods of aspects 27 to 29.
Aspect 44. An apparatus comprising means for performing any of the methods of aspects 30 to 32.
Aspect 45. A computer-readable storage medium having computer executable code stored thereon, which when executed by one or more processors, perform any of the methods of aspects 1 to 10.

A computer-readable storage medium having computer executable code stored thereon, which when executed by one or more processors, causes the one or more processors to perform any of the methods of aspects 11 to 19.

A computer-readable storage medium having computer executable code stored thereon, which when executed by one or more processors, causes the one or more processors to perform any of the methods of aspects 20 to 22.

A computer-readable storage medium having computer executable code stored thereon, which when executed by one or more processors, causes the one or more processors to perform any of the methods of aspects 23 to 26.

A computer-readable storage medium having computer executable code stored thereon, which when executed by one or more processors, causes the one or more processors to perform any of the methods of aspects 27 to 29.

A computer-readable storage medium having computer executable code stored thereon, which when executed by one or more processors, causes the one or more processors to perform any of the methods of Aspects 30 to 32.

It will be apparent that systems and/or methods described herein may be implemented in different forms of hardware, firmware, or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of various aspects. In fact, many of these features may be combined in ways not specifically recited in the claims and/or dis-closed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, and/or the like), and may be used interchange-ably with “one or more.” Where only one item is intended, the phrase “only one” or similar language is used. Also, as used herein, the terms “has,” “have,” “having,” and/or the like are intended to be open-ended terms.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B.

1. A method of wireless communication at a base station, comprising:
receiving, from one or more user equipments (UEs), a plurality of random access preambles on a physical random access channel (PRACH), each random access preamble comprising the same random access preamble sequence;
transmitting, to the one or more UEs, a response message indicating a pool of uplink (UL) resources; and
receiving, from the one or more UEs, one or more transmissions on a subset of the pool of UL resources.

2. The method of claim 1, further comprising:
determining that the plurality of random access preambles originated from different UEs, if the one or more transmissions are received on different UL resources.

3. The method of claim 1, wherein the response message is a random access response (RAR) message and the pool of UL resources comprises a plurality of UL grants.

4. The method of claim 3, wherein the received one or more transmissions comprise one or more connection request messages.

5. The method of claim 1, wherein the response message triggers transmission of a UL reference signal (RS), and the pool of UL resources comprises a pool of UL RS resources; and wherein the one or more transmissions comprise one or more UL RSs.

6. The method of claim 5, further comprising:
transmitting, to the one or more UEs, based on the received one or more UL RS, one or more random access response (RAR) messages, each RAR message indicating a different UL grant.

7. The method of claim 5, wherein the pool of UL resources is a subset of a default pool of resources which is preconfigured by remaining minimum system information (RMSI).

8. The method of claim 5, wherein the response message comprises downlink control information (DCI).

9. The method of claim 8, wherein the DCI comprises, in a field related to a physical downlink shared channel (PDSCH), timing advance (TA) information of a TA applied to the pool of UL resources.

10. The method of claim 1, wherein the base station comprises a plurality of transmission reception points (TRPs) and the plurality of random access preambles are received at different ones of the plurality of TRPs.

11. A method for wireless communication at a user equipment (UE), comprising:
transmitting, to a base station, a random access preamble on a physical random access channel (PRACH), the random access preamble comprising a random access preamble sequence;
receiving, from the base station, a response message indicating a pool of uplink (UL) resources;
randomly selecting a UL resource from the pool of UL resources; and
transmitting, to the base station, a transmission on the selected UL resource.

12. The method of claim 11, wherein the response message is a random access response (RAR) message and the pool of UL resources comprises a plurality of UL grants.

13. The method of claim 12, wherein the transmission comprises a connection request message.

14. The method of claim 11, wherein the response message triggers transmission of a UL reference signal (RS), and the pool of UL resources comprises a pool of UL RS resources; and wherein the one or more transmissions comprise one or more UL RS.

15. The method of claim 14, further comprising:
receiving, from the base station, based on the received one or more UL RS, a random access response (RAR) message indicating a different UL grant.

16. The method of claim 14, wherein the pool of UL resources is a subset of a default pool of resources which is preconfigured by remaining minimum system information (RMSI).

17. The method of claim 14, wherein the response message comprises downlink control information (DCI).

18. The method of claim 17, wherein the DCI comprises, in a field related to a physical downlink shared channel (PDSCH) timing advance (TA) information of a TA applied to the pool of UL resources.

19. The method of claim 11, wherein the base station comprises a plurality of transmission reception points (TRPs) and the plurality of random access preamble are transmitted over different ones of the plurality of TRPs.

20. An apparatus for wireless communication comprising:
at least one processor; and
a memory coupled to the at least one processor, the at least one processor being configured to:
receive, from one or more user equipments (UEs), a plurality of random access preambles on a physical random access channel (PRACH), each random access preamble comprising the same random access preamble sequence;
transmit, to the one or more UEs, a response message indicating a pool of uplink (UL) resources; and
receive, from the one or more UEs, one or more transmissions on a subset of the pool of UL resources.

21. The apparatus of claim 20, wherein the at least one processor is further configured to:
determine that the plurality of random access preambles originated from different UEs, if the one or more transmissions are received on different UL resources.

22. The apparatus of claim 20, wherein the response message is a random access response (RAR) message and the pool of UL resources comprises a plurality of UL grants.

23. The apparatus of claim 20, wherein the response message triggers transmission of a UL reference signal (RS), and the pool of UL resources comprises a pool of UL RS resources; and wherein the one or more transmissions comprise one or more UL RSs.

24. The apparatus of claim 23, wherein the at least one processor is further configured to:
transmit, to the one or more UEs, based on the received one or more UL RS, one or more random access response (RAR) messages, each RAR message indicating a different UL grant.

25. The apparatus of claim 23, wherein the response message comprises downlink control information (DCI).

26. An apparatus for wireless communication comprising:
at least one processor; and
a memory coupled to the at least one processor, the at least one processor being configured to:
transmit, to a base station, a random access preamble on a physical random access channel (PRACH), the random access preamble comprising a random access preamble sequence;
receive, from the base station, a response message indicating a pool of uplink (UL) resources;
randomly select a UL resource from the pool of UL resources; and
transmit, to the base station, a transmission on the selected UL resource.

27. The apparatus of claim 26, wherein the response message is a random access response (RAR) message and the pool of UL resources comprises a plurality of UL grants.

28. The apparatus of claim 26, wherein the response message triggers transmission of a UL reference signal (RS), and the pool of UL resources comprises a pool of UL RS resources; and wherein the one or more transmissions comprise one or more UL RS.

29. The apparatus of claim 28, wherein the at least one processor is further configured to:
receive, from the base station, based on the received one or more UL RS, a random access response (RAR) message indicating a different UL grant.

30. The apparatus of claim 28, wherein the response message comprises downlink control information (DCI).
